(19) United States
(12) Patent Application Publication
(10) Pub. No.: US 2008/0242205 A1
(43) Pub. Date: Oct. 2, 2008

(54) Portioner with multiple exits for mincemeat or the like

(76) Inventor: Giovanni Battista Righele, Zane (VI) (IT)

Correspondence Address: JACOBSON HOLMAN PLLC, 400 SEVENTH STREET N.W., SUITE 600, WASHINGTON, DC, 20004, US

(21) Appl. No.: 12/076,905

(22) Filed: Mar. 25, 2008

(30) Foreign Application Priority Data
Mar. 29, 2007 (IT) MI2007A000634

(51) Int. Cl. A22C 11/00

(52) U.S. Cl. 452/30

(57) ABSTRACT

A portioner (100) is described with multiple exits for mincemeat or the like. The portioner comprises a distribution chamber (4) for a flow of material coming from a supply pump (1) and a plurality of exit holes (101). Furthermore, the portioner (100) comprises a plurality of hollow cells (5), one for each exit, each of which is split, by means of mobile separation means (7), into two complementary compartments (5C, 5B), each of which is alternately communicating with said distribution chamber (4) and with the respective exit hole (101) by means of communication and closing means (11) that can be set so that, for each cell (5), one of said compartments (5C, 5B) can be filled with material under pressure coming from said distribution chamber (4), which pushes said means of separation (7) to force the exit of material from the other compartment (5C, 5B) towards the exit hole (101).

The present invention concerns a portioner with multiple exits for minced material or the like, in particular mincemeat.

Devices are known, such as those described in EP-A-1749444, able to portion food products such as mincemeat, for example for the production of sausages. Currently, such devices introduce mincemeat under pressure inside a portioner with parallel exits that divide a single flow of material into a plurality of separate flows from which the single sausages are made. These devices have the drawback of presenting a non-uniform pressure at the various exits.

Also known, for example from US-A-20050022870, are devices with intersecting blade eccentric pump devices assembled in a pipe. Each exit requires a pump and these are all assembled in a pipe. The drawback of this system is that the processed product must be highly compressed in order to turn the pumps, and this rotary movement is due to the pressure of the product, which damages the particles of the product which, at the end of the production process, is of low quality. Also required is a pump for each exit which is therefore very expensive. Furthermore, the device is not versatile because, once installed, exits cannot be added or removed without changing the entire container pipe and all the assembly parts. Furthermore, a lot of work and time is required for assembly and disassembly. There are a lot of parts and consequently, cleaning is difficult. Finally, synchronisation with the supply pump of the device is not possible and the offsetting for the compression and the expansion of the container pipe is not regulated.

Object of the present invention is to make a portioner with multiple exits that eliminates the above drawbacks.

In accordance with the invention, this object is achieved by means of a portioner with multiple exits for mincemeat or similar material, comprising a distribution chamber for a flow of material coming from a supply pump and a plurality of exit holes, characterized by comprising a plurality of hollow cells corresponding to said exit holes, each of which is split up, by means of mobile separation means, into two mutually complementary compartments, each of said compartments being alternately communicating with said distribution chamber and with a respective exit hole by means of communication and closing means that can be set so that, alternately, one of said compartments communicates with said distribution chamber to be filled with material under pressure and the other of said compartments communicates with said exit hole, so that said material under pressure forces said separation means to move to force the material in said other compartment towards said exit hole.

These and other characteristics of the present invention will be made clearer by the following detailed description of an embodiment thereof, illustrated in a non-limiting way on the attached drawings in which:

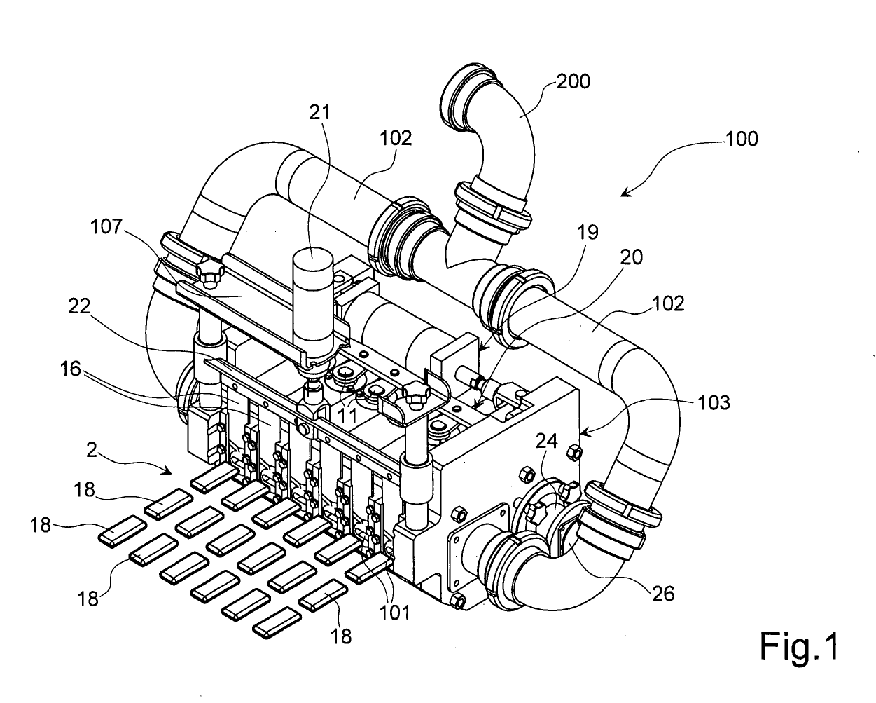

FIG. 1 shows a perspective view of a portioner according to the invention;

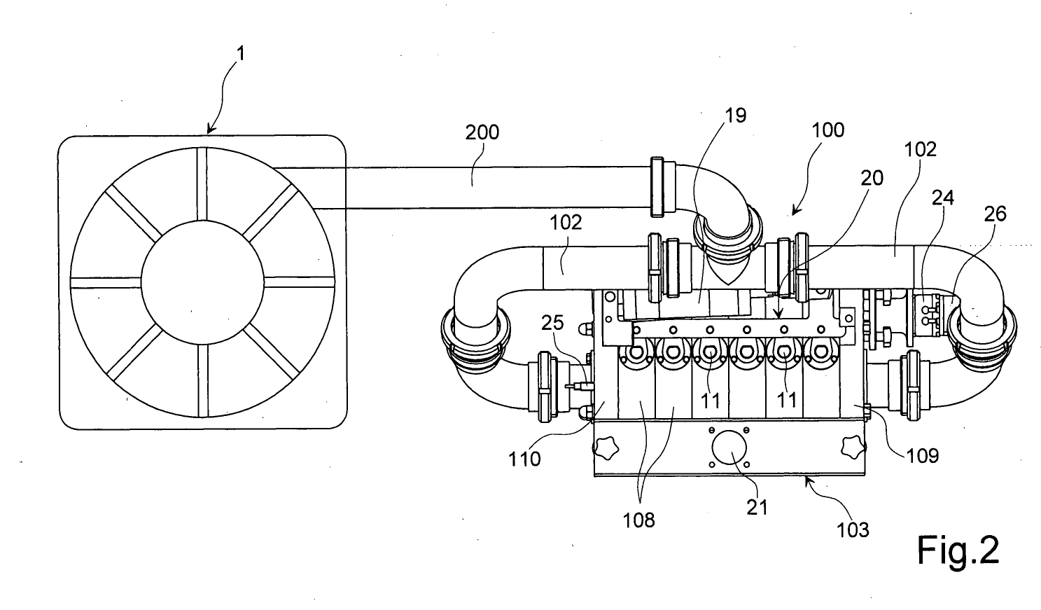

FIG. 2 shows a plan view of the portioner in FIG. 1, connected to a supply pump;

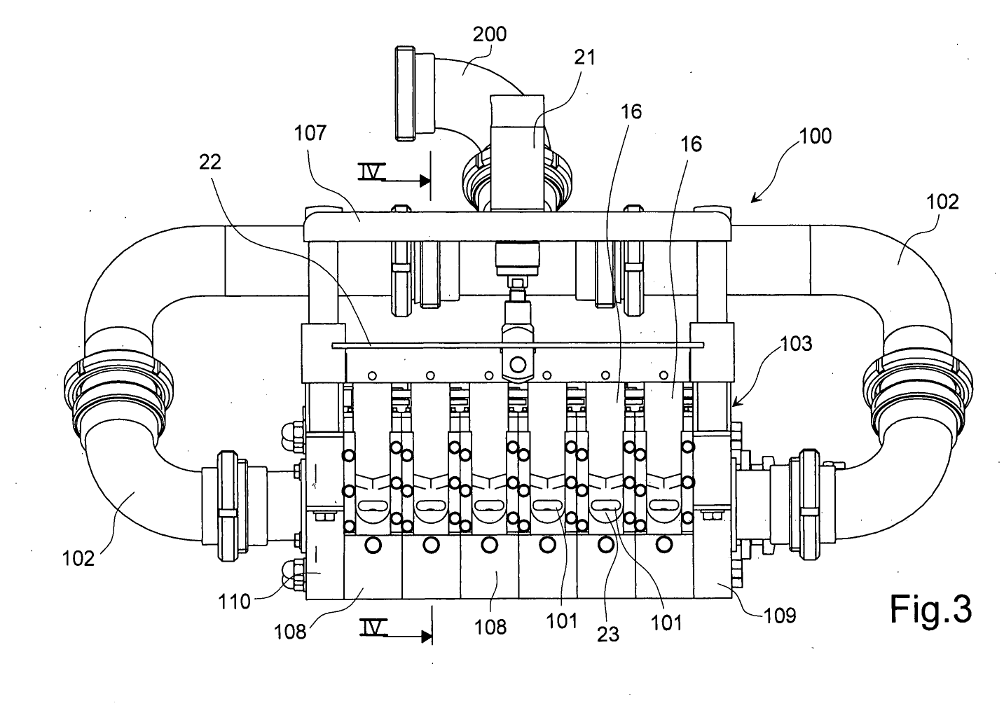

FIG. 3 shows a front view of the portioner of FIG. 1;

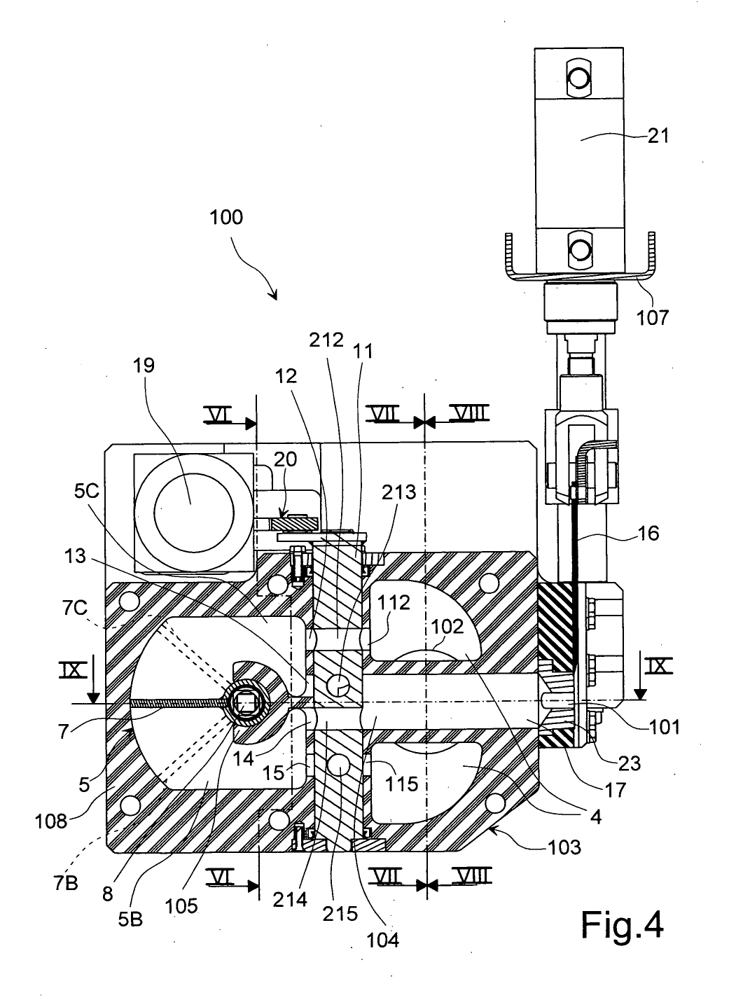

FIG. 4 shows a section according to the line IV-IV of FIG. 3, when the communication and closing means of the portioner are in a first position;

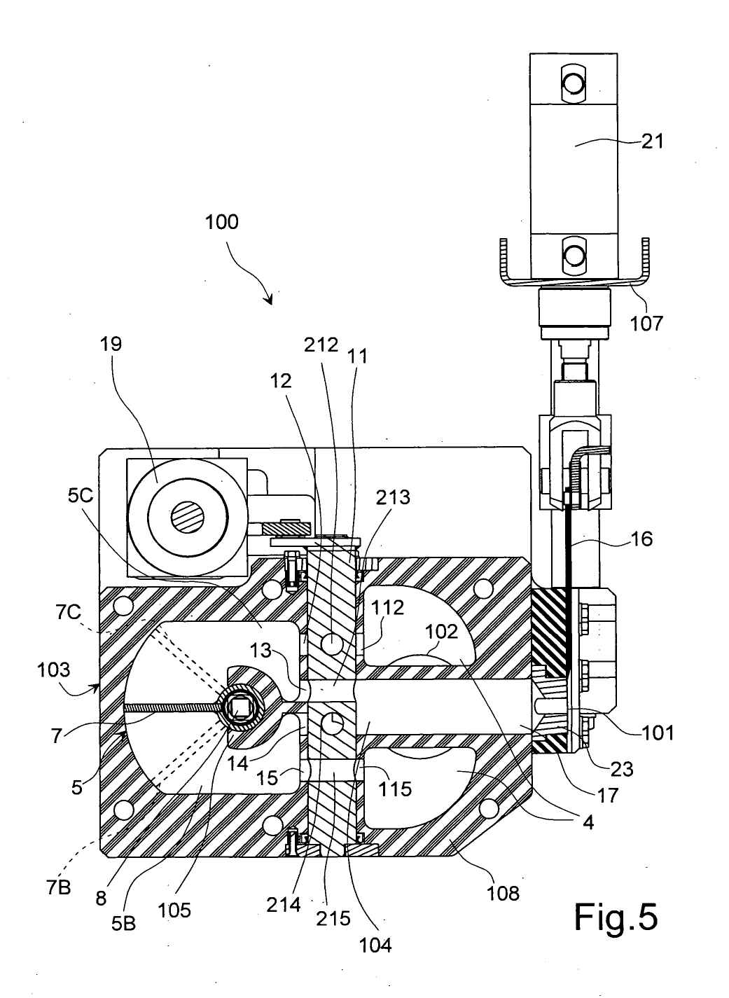

FIG. 5 shows an identical view to FIG. 4 with the communication and closing means in a second position;

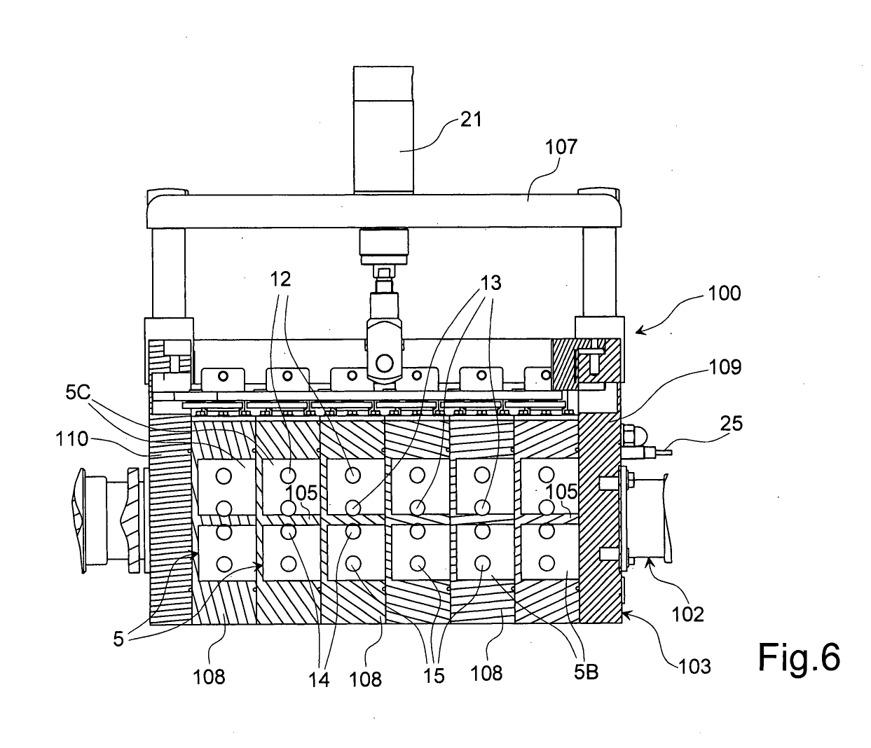

FIG. 6 shows a section according to the line VI-VI of FIG. 4;

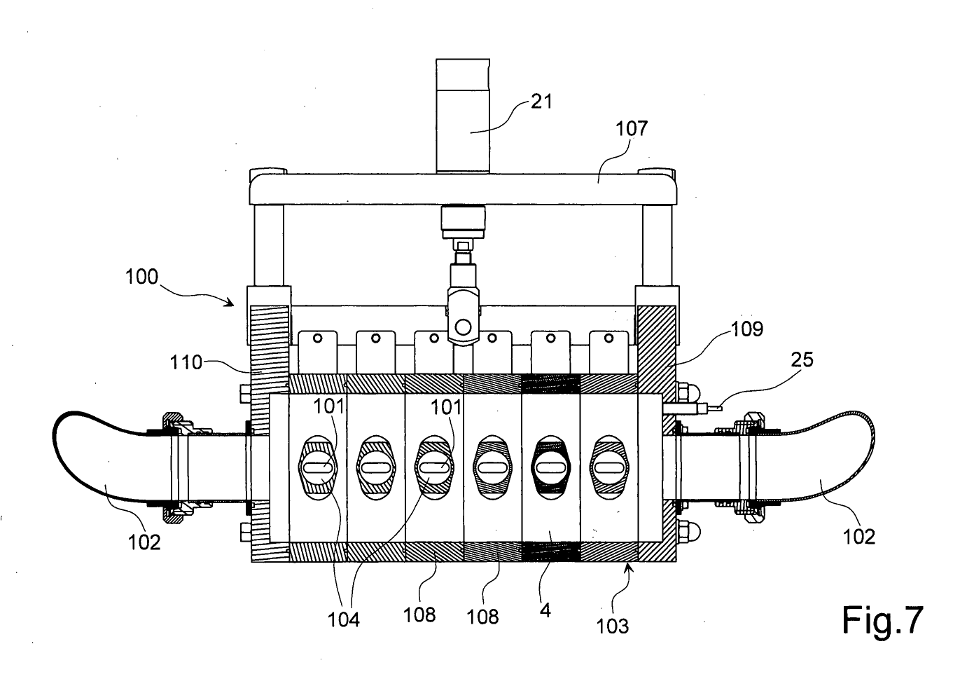

FIG. 7 shows a section according to the line VII-VII of FIG. 4;

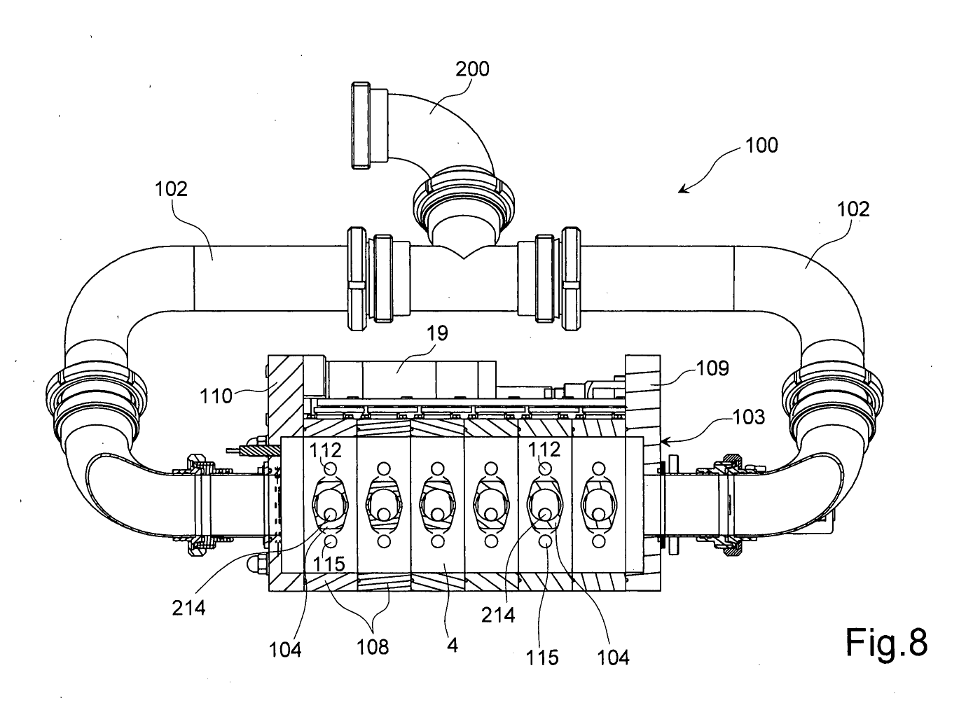

FIG. 8 shows a section according to the line VIII-VIII of FIG. 4;

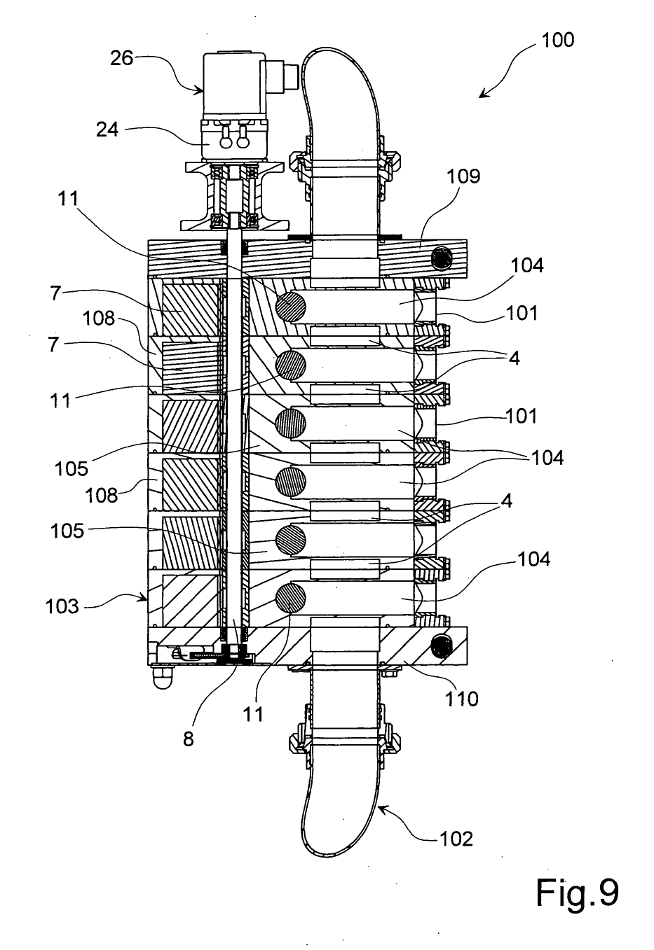

FIG. 9 shows a section according to the line IX-IX of FIG. 4;

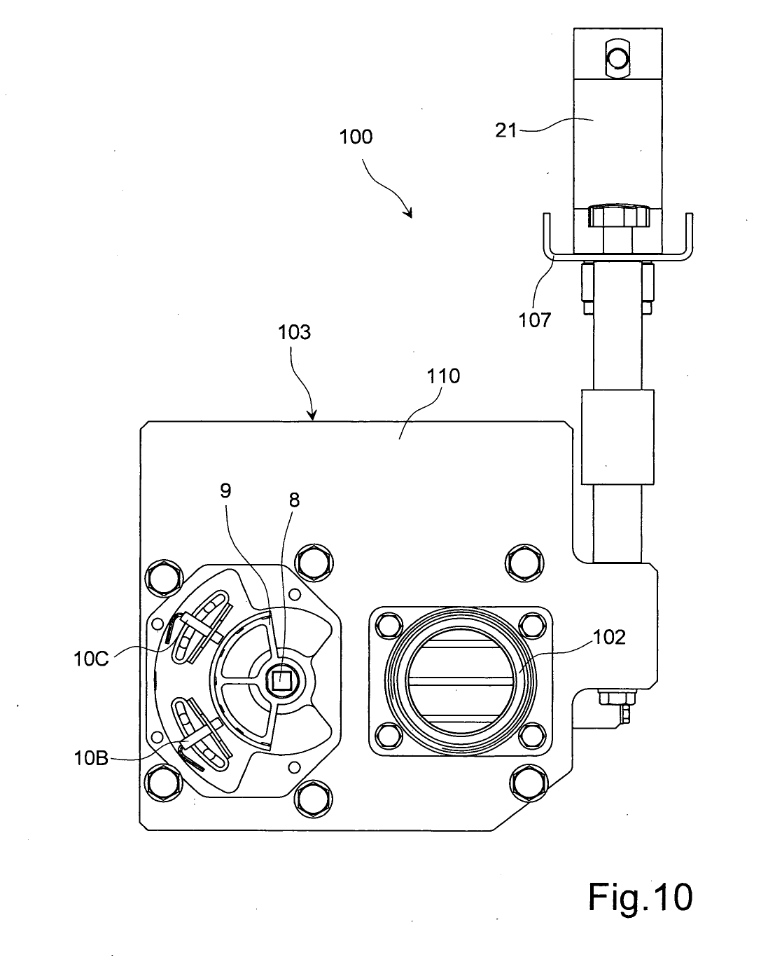

FIG. 10 shows a side view of the portioner, from the left with respect to the FIGS. 1 and 3.

A portioner 100 according to the invention is shown in FIG. 1. Through exit holes 101 finished food products 18 made up of compressed mincemeats or similar food material exit. The portioner 100 is supplied with mincemeat in loose form from pipes 102. In FIG. 2 it can be seen that such pipes 102 are linked upstream by means of a single pipe 200 to a traditional supply pump 1.

Internally, the portioner 100 is shaped as shown in FIGS. 4-9. It comprises a casing 103 made up of several portioning blocks 108 (six in the example shown but in any case in variable number) closed at the ends by two terminal blocks, right 109 and left 110 (FIG. 6). Inside the casing 103, a distribution chamber 4 is obtained that can be seen in FIGS. 4, 5, 7, 8 and 9 and is made up of a single cavity delimited by surfaces inside the casing 103.

The distribution chamber 4 is linked to the pipes 102 (FIGS. 8 and 9) and can therefore be filled with mincemeat under pressure supplied by the pump 1. It is crossed by six pipes 104 (FIGS. 7-9) integrated in the casing; above and below each pipe 104 holes 112 and 115 are present (their function will be better illustrated afterwards) which represent the exit points of the mincemeat from the distribution chamber 4.

The casing 103 is also shaped so as to embody six hollow cells 5 (FIGS. 4, 5 and 6). Each of such cells 5 can communicate with the distribution chamber 4 by means of holes 12 and 15 aligned with the above holes 112 and 115; such holes 12 and 15 are aligned with the above holes 112 and 115; such holes represent, for each cell 5, the entry points of the mincemeat. Furthermore, each cell 5 can communicate by means of holes 13 and 14 with the pipes 104; such holes 13 and 14 represent, for each cell 5, the exit points of the mincemeat towards a respective exit hole 101.

As is clearly visible in the FIGS. 4 and 5, the casing 103 embodies six protrusions 105, each of which protrudes inside one of the six cells 5. To each of such protrusions 105 a revolving blade 7 is rotatably hinged, which is able to turn, guided by the particular shape of the protrusion 105 and of the inner surface of the casing 103, to any position comprised between a first end-of-stroke position 7C and a second end-of-stroke position 7B. The blade 7 is able to split the cell 5 up hermetically into a first compartment 5B and a second compartment 5C. The movement of the blade 7 imposes a change in the volume of the compartments 5B and 5C.

All the six blades 7 are keyed to a single shaft 8, so the rotation of each blade 7 and of the shaft 8 are integral. The shaft 8 is connected to a magnetic limit switch 9 (FIG. 10) with which magnetic flow detectors 10B and 10C cooperate.

Between the distribution chamber 4 and the six cells 7, six communication and closing shafts 11 (FIGS. 4 and 5) are placed, each of which comprises the following diametral holes:
a first hole 212 suitable for allowing or closing communication between the holes 112 and 12 and therefore between the distribution chamber 4 and the compartment 5C of the cell 5;
a second hole 214 suitable for allowing or closing communication between the hole 14 and the pipe 104 and therefore between the compartment 5B of the cell 5 and the exit hole 101;
a third hole 213 suitable for allowing or closing communication between the hole 13 and the pipe 104 and therefore between the compartment 5C of the cell 5 and the exit hole 101;
a fourth hole 215 suitable for allowing or closing communication between the holes 15 and 115 and therefore between the distribution chamber 4 and the compartment 5B of the cell 5.

The first and the third hole 212 and 214 have respectively parallel axes, and the second and the fourth holes 213 and 215 have respectively parallel axes, but at right angles (even though they could even only be more oblique in other embodiments of the present invention) with respect to the axes of the first and the third hole 212 and 214.

Each closing shaft 11 can turn around its own axis so as to position in a first or second angular position.

The first position is shown in FIG. 4: the hole 212 is aligned with the holes 12 and 112 and the hole 214 is aligned with the hole 14 and the pipe 104, while the axis of the hole 213 is at right angles to the axis of the hole 13 and the axis of the hole 215 is at right angles to the axis of the hole 15: in this position, the transit of mincemeat is allowed from the distribution chamber 4 to the compartment 5C of the cell 5, and the transit of mincemeat is allowed from the compartment 5B of the cell 5 to the pipe 104 towards the exit hole 101; the path is however blocked between the compartment 5C and the pipe 104, as is the path between the distribution chamber 4 and the compartment 5B.

The second position is shown in FIG. 5: the hole 213 is aligned with the hole 13 and the pipe 104, and the hole 215 is aligned with the holes 15 and 115, while the axis of the hole 212 is at right angles to the axis of the hole 12 and the axis of the hole 214 is at right angles to the axis of the hole 14: in this position, the transit of mincemeat is allowed from the distribution chamber 4 to the compartment 5B of the cell 5 and the transit of mincemeat is allowed from the compartment 5C of the cell 5 to the pipe 104 towards the exit hole 101; the path is however blocked between the compartment 5B and the pipe 104, as is the path between the distribution chamber 4 and the compartment 5C.

All six closing shafts 11 are made to turn by the same pneumatic actuator 19 by means of lever mechanisms 20, as shown in the FIGS. 1, 2, 4 and 5.

Close to each exit hole 101 a counterpiece 23 is provided, able to give longitudinal shape to the mincemeat. Furthermore, always for each hole 101, a knife 16 is provided suitable for splitting the flow of material up into single portions 18 (FIG. 1). All six knives 16 can be operated from a single pneumatic actuator 21, supported by a frame 107 fastened to the casing 103.

The operation of the portioner 100 is described below.

The pump 1 produces a flow of mincemeat which, through the pipes 200 and 102, reaches the distribution chamber 4.

When the communication and closing shaft 11 is in the above first angular position (FIG. 4), the mincemeat is pushed through each of the holes 112, 212 and 12, inside the compartment 5C of each cell 5. The mincemeat pushes each moving blade 7, which completes a rotation in anti-clockwise direction towards the end-of-stroke position 7B. This way, the mincemeat inside the compartment 5B of each cell 5 is pushed, through the holes 14 and 214, inside the pipe 104 towards the exit hole 101.

When each blade 7 reaches the end-of-stroke position 7B, the end-of-stroke detector 10C sends a signal by means of logics able to control the pneumatic actuator 19, which by means of the lever mechanisms 20 forces the shafts 11 to move to the second angular position (FIG. 5). This way, the mincemeat is pushed, through each of the holes 115, 215 and 15, inside the compartments 5B of each cell 5. The mincemeat pushes each moving blade 7, which completes a clockwise rotation towards the end-of-stroke position 7C. This way, the mincemeat inside the compartment 5C of each cell 5 is pushed through the holes 13 and 213, inside the pipe 104 towards the exit hole 101.

The product runs along the pipe 104 and reaches the counterpiece 23, inside which it achieves the preferred longitudinal shape and is cut crossways to form the finished product pieces 18.

Below is a list of further features of the present invention.

The use can be envisaged of an electromagnetic brake 24 (FIGS. 2 and 9) able to brake the shaft 8 in a controlled way (e.g., with adjustable predefined tension), so as to offset the pressure of the entrance of the meat into each chamber 5B and 5C.

The use can also be envisaged of an instantaneous pressure sensor 25 (FIG. 7) able to measure the pressure of the mincemeat so as to send, in case a pressure is detected considered to be dangerously high, an alarm signal to the control means of the pump 1, which is stopped. Such an occurrence can take place for example when one of the pneumatic actuators 19 or 21 is blocked.

The possibility exists of using an angular position transducer 26 (FIGS. 1, 2 and 9), e.g., an encoder, keyed to the shaft 8 so as to measure the movement performed by the blades 7: this allows exactly knowing the flow of product dispensed by the portioner, so as to control the quantity of mincemeat reaching the exit hole 101.

It should be pointed out that the pump 1, generally, does not operate in continuous cycle, but stops every time a predefined quantity of mincemeat reaches the exit hole 101: when this occurs, cutting is commanded by means of the knives 16, on the part of the actuator 21. The pump 1 stop request is made by means of a signal due to the angular position transducer 26 or by means of a portion value preset on the filling pump 1.

1. Portioner with multiple exits for mincemeat or similar material, comprising a distribution chamber for a flow of material coming from a supply pump and a plurality of exit holes, characterized by comprising a plurality of hollow cells corresponding to said exit holes, each of which is split up by means of mobile separation means into two mutually complementary compartments, each of said compartments being alternately communicating with said distribution chamber and with a respective exit hole by means of communication and closing means which can be set so, alternately, one of said compartments communicates with said distribution chamber to be filled with material under pressure and the other of said compartments communicates with said exit hole, and consequently said material under pressure pushes said separation means to move the material in said other compartment towards said exit hole.

2. Portioner as claimed in claim 1, characterized in that said communication and closing means can be alternately set in a first position, in which one of said compartments communicates with said distribution chamber and the other compartment communicates with the exit hole, and a second position in which said one compartment communicates with the exit hole and said other compartment communicates with said distribution chamber.

3. Portioner as claimed in claim 2, characterized in that said communication and closing means include a rotating shaft for each of said cells, said shaft having diametral holes, of which a first hole is able to achieve the communication between said distribution chamber and a first compartment and a second hole substantially parallel to the first hole is able to achieve the communication between a second compartment and the exit hole when said shaft is in a first position, while a third hole substantially perpendicular to the first two is able to achieve the communication between said first compartment and the exit hole and a fourth hole substantially parallel to the third hole is able to achieve the communication between said second compartment and said distribution chamber when said shaft is in a second position.

4. Portioner as claimed in claim 1, characterized in that said mobile separation means include swivel blades.

5. Portioner as claimed in claim 4, characterized in that all said blades are keyed on a single rotating shaft.

6. Portioner as claimed in claim 5, characterized in that said single shaft and said blades are able to turn between a first and a second end-of-stroke position, sensor means being provided able to detect when said first and second end-of-stroke positions have been reached and send a signal to logic means able to change the position of said blockage means.

7. Portioner as claimed in claim 5, characterized in that said single shaft can be braked by means of an electro-magnetic brake.

8. Portioner as claimed in claim 1, characterized in that close to each of said exit holes a counter-piece is located for longitudinal shaping of the exiting flow of material.

9. Portioner as claimed in claim 1, characterized in that close to each of said exit holes an operating knife is located for the separation of the flow of exiting material into single portions.

10. Portioner as claimed in claim 1, characterized by comprising a pressure sensor for the material supplied by the pump.

11. Portioner as claimed in claim 1, characterized by comprising an encoder fitted to said shaft to detect the quantity of the flow of material supplied by the pump.

12. Portioner as claimed in claim 1, characterized in that said distribution chamber is made inside a casing split into adjacent blocks closed by end blocks.
